(19) United States
(12) Patent Application Publication
(10) Pub. No.: US 2011/0089864 A1
(43) Pub. Date: Apr. 21, 2011

(54) Method and Apparatus for Controlling Power in a LED Lighting System

(76) Inventors: Cory Wasniewski, Oak Creek, WI (US); Jeremy J. Fredrich, Greendale, WI (US); David Mundschau, Waukesha, WI (US)

(21) Appl. No.: 12/907,380

(22) Filed: Oct. 19, 2010

Related U.S. Application Data
(60) Provisional application No. 61/279,326, filed on Oct. 19, 2009.
(60) Provisional application No. 61/262,821, filed on Nov. 19, 2009.

(51) Int. Cl. H05B 37/02; H05B 37/00

(52) U.S. Cl. 315/295; 315/313

(57) ABSTRACT

The LED light fixture includes white LEDs having multiple, different color temperatures. Preferably, white LEDs having color temperatures of about 3500 and about 5000 degrees Kelvin (K) are selected. The intensity of each LED may be varied and the light radiated from the LEDs is mixed together. The resulting light emitted from the housing is a white light having a variable color temperature ranging from about 3500 to about 5000 K. The housing is preferably extruded aluminum. A portion of the housing is configured to mix the light together and to focus the light such that the output light is about thirty degrees off center. Electrical loading is off set to minimize load on power supplies.

### CROSS-REFERENCE TO RELATED APPLICATIONS

This application claims priority to U.S. provisional application Ser. Nos. 61/279,326, filed Oct. 19, 2009, and 61/262,821, filed Nov. 19, 2009, both applications entitled “LED Lighting System,” and the entire contents of both applications are incorporated herein by reference.

### BACKGROUND OF THE INVENTION

1. Field of the Invention

The subject matter disclosed herein relates to light-emitting diode (LED) lighting systems. More specifically, a method of controlling the power supplied to the LEDs in the lighting system is disclosed.

2.Discussion of the Related Art

Historically, artificial lighting has taken many forms. Artificial lighting has progressed from early flame sources, to modern light fixtures, such as incandescent or fluorescent bulbs. Improvements in artificial lighting have often been driven by desires to provide more natural and/or more efficient lighting. Recent improvements in LED technology have resulted in the development of LEDs with sufficient intensity produced at an inexpensive price such that LEDs are now often considered an available option in artificial light source applications.

Modern light fixtures have also become increasingly application specific. One example of an application for a light fixture having specific requirements is wash lighting in the passenger compartment of a vehicle, such as an aircraft cabin. Typically, these light fixtures utilize fluorescent fixtures spaced consecutively along the length of the passenger compartment. These fluorescent fixtures may be incorporated into a passenger service unit (PSU) extending along an upper portion of the compartment. The PSU may contain multiple functions including, but not limited to, lighting, regulatory indicators, service indicators, ventilation, and hand holds. The light fixtures included within the PSU may provide wash lighting upward and/or downward from the PSU. In order to minimize the size of the PSU and, consequently, the space it occupies in the passenger compartment, it would be desirable to provide a light fixture requiring minimal space within the PSU yet providing sufficient illumination for the passenger compartment.

In addition, the light fixtures may be recessed substantially within the PSU providing a narrow angle of emission at which light may be radiated from an opening in the PSU or from between the PSU and a wall of the compartment. Light that is emitted from the fixture at angles greater than the angle of emission for the opening will either be absorbed into or reflected by the surface of the PSU, reducing the efficiency of the light fixture. Previous attempts to improve the efficiency of such light fixtures include placing an optic, or lens, over the output of the LED module or fixture. The optic receives the radiated light and refracts the light such that the majority of light emitted from the optic is at a narrow enough angle to exit the opening in the PSU. However, adding optics to the light fixtures increases complexity and cost. Consequently, it would be desirable to provide a fixture capable of emitting light at a narrow angle without the use of optics.

Additionally, providing artificial lighting that most nearly represents natural lighting is also desirable. Natural lighting changes color temperatures throughout the course of a day, beginning with a warmer temperature in the morning, becoming a cooler temperature during the middle of the day, and returning to a warmer temperature in the evening Additionally it may be desirable to select color temperatures to match fabrics for the aircraft and change color temperatures for specific events such as meal time and work time. However, typical light fixtures, such as fluorescent or incandescent bulbs, output white light at a single color temperature. Thus, it would be desirable to utilize multiple white LEDs having different color temperatures in a single fixture to provide a range of color temperatures within the passenger compartment.

### SUMMARY OF THE INVENTION

Consistent with the foregoing and in accordance with the subject matter as embodied and broadly described herein, a LED lighting fixture utilizing multiple white LEDs to provide wash lighting is described in suitable detail to enable one of ordinary skill in the art to make and use the invention.

The LED light fixture includes multiple white LEDs having different color temperatures. Preferably, white LEDs having color temperatures of about 3500 and about 5000 degrees Kelvin (K) are selected. The intensity of each LED may be varied and the light radiated from the LEDs is mixed together. The resulting light emitted from the housing is a white light having a variable color temperature ranging from about 3500 to about 5000 K. The housing is preferably extruded aluminum. In a preferred embodiment, a portion of the housing is configured to mix the light together and to focus the light such that the output light is about thirty degrees off center.

More specifically, in one embodiment of the invention, a light fixture for wash lighting includes a housing having an elongate first wall and second wall. The first and second walls are spaced apart from and generally parallel to each other. The housing includes a reflector portion having at least two segments. A first segment of the reflector portion is defined by a parabolic function, and a second segment of the reflector portion is defined by an elliptical function. A light source is positioned within the housing generally at a focus of the parabolic function.

As another aspect of the invention, the reflector portion is symmetric about an axis located between the first wall and the second wall. The light source is preferably a plurality of light emitting diodes (LEDs) mounted along an axis of symmetry between the first and the second walls substantially along a length of the housing. Additionally, the axes of symmetry of the parabolic and elliptical functions are coincident with the axis of symmetry of the reflector portion, and the parabolic function and the elliptical function have a common focus.

As yet another aspect of the invention, the surface of the reflector portion is substantially specular and preferably receives no coatings that affect the reflective characteristics of the surface. The housing further includes a channel positioned below the reflector portion and a support for the light source within the channel. The support may be integrally formed with the channel to define a rib extending along at least a portion of each wall of the channel. The light source may include a plurality of LEDs mounted to a first surface of a circuit board and an electronic circuit configured to provide power to the LEDs mounted to a second surface, opposite of the first surface, of the circuit board. The circuit board slidably engages the support ribs in the light fixture.

According to another embodiment of the invention, a light fixture providing a focused output light includes a housing having a first side wall with a first lower section and a first upper section, a second side wall with a second lower section and a second upper section, and a lower surface connecting the first side wall and the second side wall at a lower edge of each of the first and second lower sections, respectively. A circuit board engages a first support connected to the first lower section and a second support connected to the second lower section. The first and second supports are spaced from the lower surface a substantially equal amount. A plurality of LEDs are mounted to an upper surface of the circuit board and oriented to emit light between the first upper section and the second upper section. The first and second upper sections are generally curved surfaces, and each LED is positioned substantially at a focus of the curve. An electronic circuit configured to provide power to the LEDs is mounted to a lower surface of the circuit board and the circuit board slidably engages the first and second supports.

According to another aspect of the invention, the first and the second upper sections include a first segment which is generally elliptical and a second segment which is generally parabolic, and the parabolic and elliptical functions have a substantially common focus.

According to yet another aspect of the invention, the housing is configured to be mounted relative to at least one aperture so that light rays reflected by the first segment intersect at a focal point generally aligned with the aperture.

In another embodiment of the invention, a light fixture provides a white light output of varying color temperatures. The light fixture includes a plurality of first LEDs emitting a white light characterized by a first color temperature and a plurality of second LEDs emitting a white light characterized by a second color temperature. The light fixture also includes a memory device storing a series of instructions executable on a processor, and a processor configured to execute the series of instructions. The processor independently controls the intensity of the first LEDs and the intensity of the second LEDs to generate a white light output at a desired color temperature at or between the first color temperature and the second color temperature. The second color temperature differs from the first color temperature by less than 2000 degrees Kelvin. The light fixture may also include an input to the processor configured to receive a reference signal corresponding to a desired color temperature.

As still another aspect of the invention, the plurality of first LEDs are selected from a group of LEDs having a first range of color temperatures, and the plurality of second LEDs are selected from a group of LEDs having a second range of color temperatures. First compensation data is stored in the memory device and used by the processor to control the light output from the light fixture at a color temperature substantially equal to the first color temperature when the desired color temperature is the first color temperature. Second compensation data is stored in the memory device and used by the processor to control the light output from the light fixture at a color temperature substantially equal to the second color temperature when the desired color temperature is the second color temperature.

According to still another embodiment of the invention, a light fixture provides a white light output of varying color temperatures. The light fixture includes a housing having a first wall, a second wall spaced apart from the first wall, a bottom surface connecting the first wall and the second wall, and a generally open upper surface. At least an upper portion of the first and second walls are configured to reflect light toward the upper surface. A circuit board is positioned within the housing. At least one first LED mounts on a first surface of the circuit board, the first surface of the circuit board facing the upper surface of the housing, and emits a white light characterized by a first color temperature. At least one second LED mounts on the first surface of the circuit board and emits a white light characterized by a second color temperature. A controller independently controls the intensity of the first LEDs and the second LEDs wherein the color temperatures of the light output from the light fixture varies by less than 2000 degrees Kelvin.

As another aspect of the invention, the housing is generally elongate and the LEDs are linearly positioned along the length of the circuit board between the first and the second wall. Each of the first and second LEDs are alternately placed along the length of the circuit board, and the controller uses a pulse width modulation (PWM) technique to control the intensity of the first and second LEDs.

In yet another embodiment of the present invention, a light fixture providing a focused white light output of varying color temperatures includes at least one first LED emitting a white light characterized by a first color temperature and at least one second LED emitting a white light characterized by a second color temperature. A controller independently controls the intensity of the first LEDs and the intensity of the second LEDs wherein the color temperatures of the light output from the light fixture varies over a range of about 1500 degrees Kelvin. An elongate housing includes a first side wall having a first lower section and a first upper section, a second side wall having a second lower section and a second upper section, and a lower surface connecting the first lower section and the second lower section. A circuit board is mounted between the first and the second lower sections, such that each of the first LEDs and the second LEDs are mounted to an upper surface of the circuit board to emit light upward between the first upper section and the second upper section. The first upper section and the second upper section are generally curved surfaces, wherein a first segment of the curved surface is generally elliptical and a second segment of the curved surface is generally parabolic.

According to still another embodiment of the present invention, a modular lighting system includes a voltage source and a plurality of lighting modules. Each lighting module includes at least one light source, a power supply electrically connected to the voltage source and configured to regulate a current output from the power supply, a processor configured to receive a reference signal and to output a control signal corresponding to the reference signal, and at least one switch selectively establishing an electrical connection between the power supply and the light source according to the control signal. The electrical connections for the lighting modules are established at different times.

As yet another aspect of the invention, each lighting module includes an input configured to receive a synchronizing signal from at least one of the other lighting modules and an output configured to transmit a corresponding synchronizing signal to at least one of the other lighting modules. Each lighting module also includes a memory device storing a delay time. In response to the control signal, a first of the lighting modules establishes the electrical connection between the power supply and the light source and generates the synchronizing signal for transmission to another of the lighting modules. Each of the other lighting modules sequentially receives one of the synchronizing signals from another of the lighting modules, waits for the delay time, establishes the electrical connection between the power supply and the light source, and generates the corresponding synchronizing signal for transmission to another of the lighting modules.

In another embodiment of the present invention, a modular lighting system includes a voltage source and a plurality of lighting modules. Each lighting module includes a LED light source and a power supply electrically connected to the voltage source. The power supply is configured to regulate a current output from the power supply to the LED light source. A switch connected in series between the power supply and the LED light source establishes an electrical connection between the power supply and the LED light source in a first operating mode and breaks the electrical connection between the power supply and the LED light source in a second operating mode. A processor configured to execute a PWM algorithm having a switching period includes a control output to select either the first or the second operating mode of the switch, an input configured to receive a synchronizing signal from one of the other lighting modules, and an output configured to transmit a corresponding synchronizing signal to one of the other lighting modules. A memory device is in communication with the processor and stores a delay time which is a function of the number of lighting modules and the switching period. The processors of each of the lighting modules are synchronized to select either the first or the second operating mode of their respective switch at a different time.

According to another aspect of the invention, one of the lighting modules is designated as a master module and each of the remaining lighting modules are designated as a follower module. The master module alternately toggles the switch between the first operating mode and the second operating mode for a percentage of the switching period corresponding to a desired intensity of light radiated from the LED light source. The master module generates the synchronizing signal for transmission to a first of the follower modules when the switch is in the first operating mode. Each follower module successively receives the synchronizing signal, waits for the delay time, sets its respective switch to the first operating mode, and generates a new synchronizing signal for transmission to the next follower module.

According to another embodiment of the invention, a method of controlling power supplied to a light system having a plurality of light modules includes the steps of receiving a reference signal corresponding to a desired intensity of light, determining an on time for connecting a light source to a power supply on each light module as a function of the desired intensity and a switching period, energizing each light source for the on time, wherein the on time is a portion of the switching period, and staggering the start of the on time by a delay time for each successive light source. The delay time is substantially equal to the switching period divided by the number of light modules in the light system.

As yet another aspect of the invention, each of the light modules are connected in series. The synchronizing signal is generated at the start of the on time for each light module, and transmitted to the next light module. The on time of a first light module is synchronized with the start of the switching period, and the on time of each subsequent light module begins after receiving the synchronizing signal from the prior light module and waiting for the delay time.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the subject matter disclosed herein are illustrated in the accompanying drawings in which like reference numerals represent like parts throughout, and in which:

FIG. 1 is an isometric view according to one embodiment of a LED light fixture;

FIG. 2 is a cross-sectional view of the housing for the fixture in FIG. 1;

FIG. 3 is an isometric view of the housing for the fixture in FIG. 1;

FIG. 4 is an illustration of an exemplary aircraft cabin incorporating the light fixture of FIG. 1;

FIG. 5 is a partial cross-section of the exemplary aircraft cabin of FIG. 4, illustrating a PSU;

FIG. 6 is a block diagram representation of an exemplary system incorporating the light fixture of FIG. 1;

FIG. 7 is a block diagram representation of the control system for one of the light fixtures of FIG. 6;

FIG. 8 is an exemplary timing diagram illustrating delivery of power to multiple light fixtures;

FIG. 9 is a cross-sectional view of the housing for another embodiment of the LED light fixture according to the present invention;

FIG. 10 is a partial top view of the fixture of FIG. 9 placed on end to illustrate the pattern of light emitted from the housing;

FIG. 11 is a cross-sectional view of the housing according to one embodiment of the present invention having a generally parabolic curvature;

FIG. 12 is a cross-sectional view of the housing according to one embodiment of the present invention having a generally elliptical curvature; and

FIG. 13 is a cross-sectional view of the housing according to one embodiment of the present invention having a combined parabolic and elliptical curvature.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

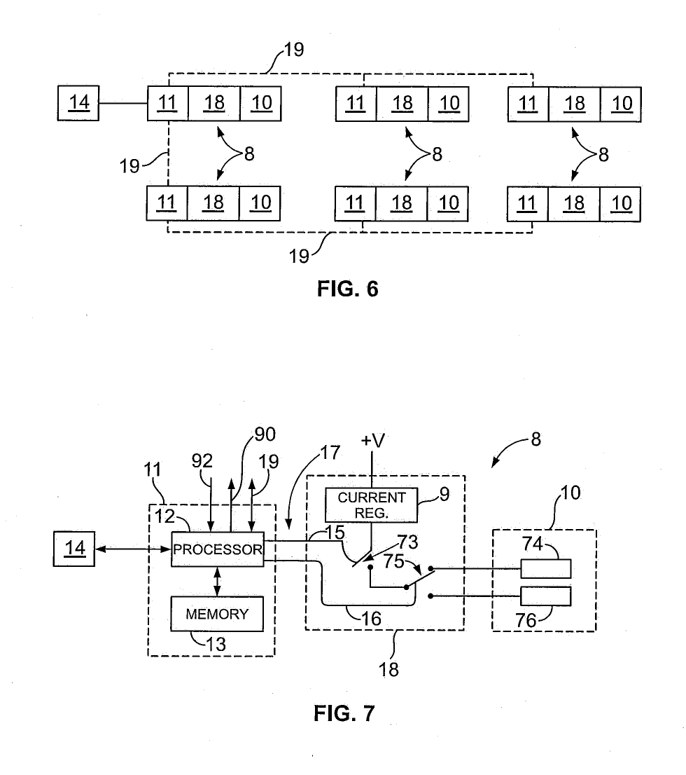

Referring to FIGS. 6 and 7, a light fixture 8 according to the present invention emits light according to control signals 17 generated by a controller 11. The controller 11 includes a processor 12 capable of executing a stored program. The program may be stored in memory 13 and may similarly access the memory 13 while executing on the processor 12. An operator, for example a pilot, flight attendant, or a passenger, may interact with an interface unit 14 to provide a desired set point for the light fixture 8. The set point is preferably a function of both a desired intensity, or brightness, and a desired color temperature of the light. The set point is transmitted from the interface unit 14 to the controller 11.

The processor 12 in the controller 11 converts the set point to appropriate control signals 17, such as an intensity command signal 15 and a color temperature command signal 16, for the power supply 18. The processor 12 may be mounted on each fixture 8 or, optionally, one processor 12 may provide control signals 17 to multiple fixtures 8. The control signals 17 may be transmitted, for example, over discrete conductors, an RS-485 network, or any other suitable communication line as is known in the art.

The power supply 18 uses the control signals 17 to provide power to the light source 10. Preferably, the light source 10 includes multiple LEDs 72 and may include a first set of LEDs 74 and a second set of LEDs 76. Each of the first and second set of LEDs, 74 and 76, generates light having different characteristics. The light source may radiate light generated entirely by the first set of LEDs 74, the second set of LEDs 76, or combine light from both sets of LEDs, providing a variable light source 10.

The intensity command signal 15 is used to vary the brightness of the light generated by the light source 10. According to one embodiment of the invention, the power supply 18 includes a current regulator 9. The current regulator 9 can provide a constant current output to the light source. The intensity command signal 15 is used to open and/or close a switch 73, establishing an electrical connection between the current regulator 9 and the light source 10. The switch 73 is preferably alternately opened and closed as discussed in more detail below, resulting in an average on time of the light source 10.

The color temperature command signal 16 is used to vary the characteristics of the light generated by the light source 10. For example, each of the first and second set of LEDs, 74 and 76 respectively, is preferably selected to radiate light at a different color temperature. The color temperature command signal 16 is used to open and/or close a switch 75 to select which set of LEDs receives power from the power supply 18. The switch 75 may direct power entirely to one set of LEDs causing the light source 10 to radiate light at the color temperature for the selected set of LEDs. Optionally, the color temperature command signal may alternately open and close the switch 75 resulting in an average color temperature generated by the light source 10 at a point between the color temperatures of either of the sets of LEDs. These features are discussed in more detail below.

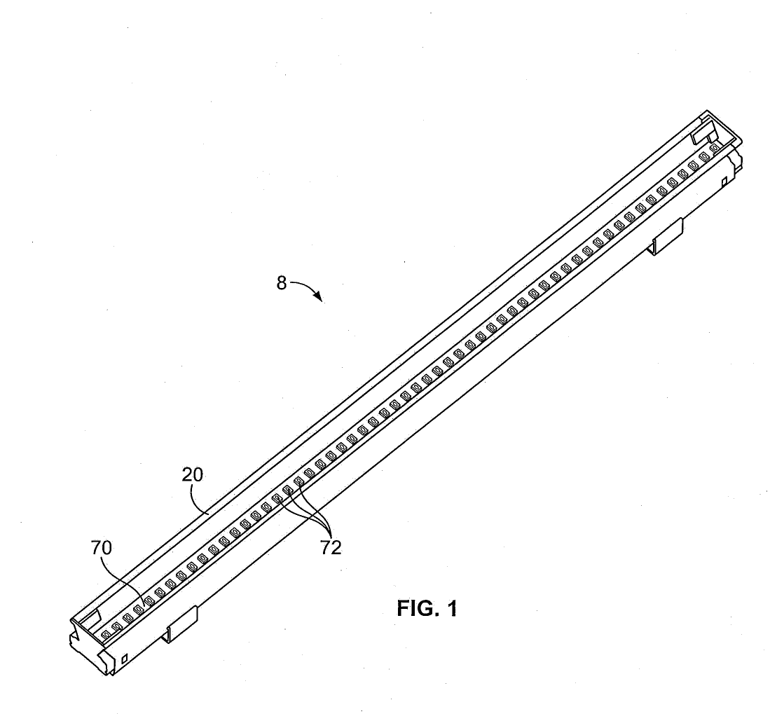

Referring to FIGS. 1-3, a first embodiment of a LED light fixture 8 according to the present invention includes an elongate housing 20 having a first side wall 22; a second side wall 24, generally opposite of the first side wall 22; and a lower surface 26. The housing 20 is generally open along an upper face 25 of the housing 20. The lower surface 26 extends generally perpendicular to the first side wall 22 and the second side wall 24, connecting the side walls, 22 and 24, at a lower edge of each wall. The first side wall 22 includes a first lower section 28 and a first upper section 32, and the second side wall 24 includes a second lower section 30 and a second upper section 34. Each of the lower sections, 28 and 30, is generally straight, and a u-shaped channel 36 is formed between the first lower section 28, the second lower section 30 and the lower surface 26. Optionally, each of the lower sections, 28 and 30, may further include a recessed portion 38 extending into the channel and extending longitudinally along the housing 20. The lower surface 26 may include one or more offset members, or feet, 40 extending outwardly from the lower surface 26 and extending longitudinally along at least a portion of the housing 20. Preferably, the recessed portions 38 and the feet 40 extend longitudinally along the length of the housing 20. In addition, it is contemplated that other suitable shapes and cross-sectional areas may be used for the lower section to accommodate the requirements of a particular installation, such as mounting, structural, or air flow requirements, or the like.

The inner surface of the first lower section 28 and the second lower section 30 include a first support 42 and a second support 44, respectively, extending longitudinally along the channel 36. Preferably, each support, 42 and 44, includes a rib 46 extending from the inner surface of each of the first and second lower sections, 28 and 30, into the channel 36 and extending longitudinally along at least a portion of the channel 36. Optionally, the supports, 42 and 44, may be integrally formed or machined into the lower sections, 28 and 30. The supports, 42 and 44, are preferably positioned near the upper end of each of the lower sections, 28 and 30, and disposed opposite of each other. The supports, 42 and 44, are configured to engage and, at least in part, support a circuit board 70 extending between the first lower section 28 and the second lower section 30.

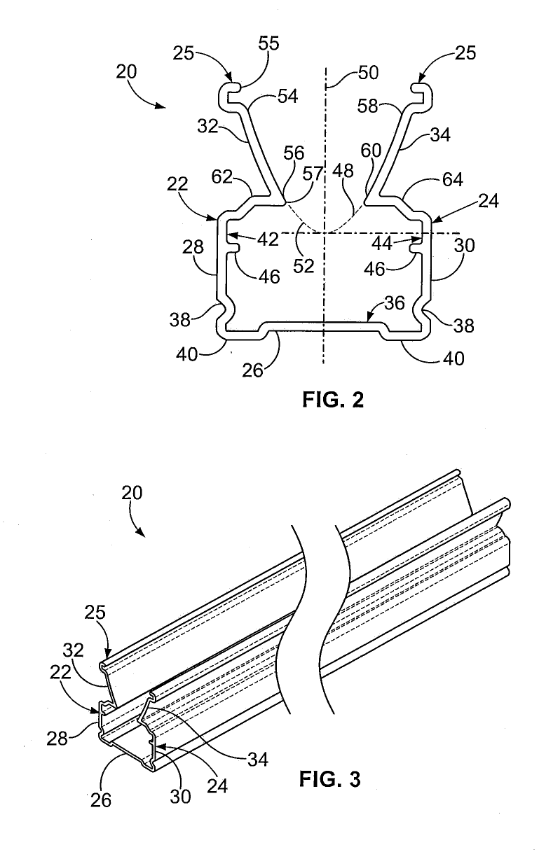

Each of the upper sections, 32 and 34, are generally curved surfaces. According to a first embodiment of the present invention, illustrated in FIGS. 2 and 3, the curvature of the first upper section 32 corresponds to the curvature of a first leg of a parabola 48 and the curvature of the second upper section 34 corresponds to the curvature of a second leg of the parabola 48. The parabola 48 has an axis of symmetry that is preferably coincident with a central axis 50 of the housing 20 and the inner portion 52 of the parabola 48 is disposed within the channel 36 of the housing 20. A first end 54 of the first upper section 32 is disposed near the upper face 25 of the housing 20. The first upper section 32 curves inward from the first end 54 to a second end 56 of the first upper section 32. A first end 58 of the second upper section 32 is disposed near the upper face 25 of the housing 20. The second upper section 32 curves inward from the first end 58 to a second end 60 of the second upper section 32. A first opening 55 extends between the first ends, 54 and 58, and a second opening 57 extends between the second ends, 56 and 60.

According to another embodiment of the present invention, illustrated in FIG. 9, the curvature of each upper section, 32 and 34, is divided into at least two segments. For example, a first segment 31 of the first upper section 32 may be generally elliptical and a second segment 33 of the first upper section 32 may be generally parabolic. Similarly, a first segment 35 of the second upper section 34 may be generally elliptical and a second segment 37 of the second upper section 34 may be generally parabolic. Each of the curvilinear functions, for example a parabola 48 or an ellipse 49, defining the curvature of each segment preferably includes a common focus 51 and axes of symmetry that are coincident with a central axis 50 of the housing 20. The inner portions, 52 and 53, of the parabola 48 and ellipse 49, respectively, are disposed within the channel 36 of the housing 20. A first end 54 of the first upper section 32 is disposed near the upper face 25 of the housing 20. The first upper section 32 curves inward from the first end 54 to a second end 56 of the first upper section 32. A first end 58 of the second upper section 32 is disposed near the upper face 25 of the housing 20. The second upper section 32 curves inward from the first end 58 to a second end 60 of the second upper section 32. A first opening 55 extends between the first ends, 54 and 58, and a second opening 57 extends between the second ends, 56 and 60.

A first middle section 62 connects the second end 56 of the first upper section 32 and the upper end of the first lower section 28. Preferably, at least a portion of the first middle section 62 extends generally perpendicular to the first lower section 28. The first middle section 62, in cooperation with a rib 46 on the first lower section 28, preferably defines the first support 42. A second middle section 64 connects the second end 60 of the second upper section 34 and the upper end of the second lower section 30. Preferably, at least a portion of the second middle section 64 extends generally perpendicular to the second lower section 30. The second middle section 64, in cooperation with a rib 46 on the second lower section 30, preferably defines the second support 44. The ribs 46 are preferably disposed at a distance along each lower section, 28 and 30, set off from each of the middle sections, 62, and 64, such that the circuit board 70 slidably engages the housing 20 between the ribs 46 and the middle sections, 62 and 64.

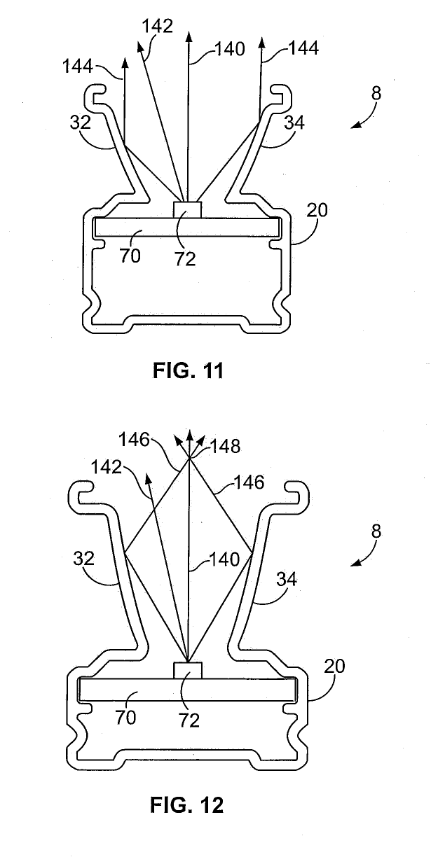

Referring also to FIGS. 11-13, the circuit board 70 preferably includes electrical components (not shown) on a first side of the circuit board 70, the electrical components providing power to and control of LEDs 72 on the second side of the circuit board 70. Preferably, the circuit board 70 on which the LEDs 72 are mounted slidably engages the supports, 42 and 44, and the LEDs 72 are positioned in a row extending longitudinally down the center of the circuit board 70. The LEDs 72 extend toward the first opening 55 between the upper sections, 32 and 34. Preferably, the LEDs are positioned to emit light at a point generally coincident with the focus 51 of the curved upper sections, 32 and 34. Optionally, multiple circuit boards 70 may be inserted into the supports, 42 and 44, adjacent to each other, and still other embodiments may include multiple supports displaced along the lower section 30 such that separate circuit boards 70, for example, for the electrical components and the LEDs 72, may be positioned one above the other. In still other embodiments, the electrical components may be mounted within the channel 36 according to any suitable method known in the art.

Any suitable LED 72, as would be known to one skilled in the art, may be used in the light fixture 8. Preferably, Lambertian LEDs 72 are arranged in a single row extending longitudinally along the circuit board 70. Lambertian LEDs 72 have an off center angle of about sixty degrees, where the off center angle is the angle at which the intensity of the light is one half the intensity of the light emitted on axis, or emitted straight from the LED 72. LEDs 72 having different color spectra or color temperatures are included on the circuit board 70. Preferably, a first set of white LEDs 74 having a first color temperature are alternately mounted on the circuit board 70 with a second set of white LEDs 76 having a second color temperature.

In another aspect of the invention, the upper sections, 32 and 34, may have channels formed at the first ends, 54 and 58. The channels are configured to retain a cover (not shown) at the upper face 25 of the housing 20. Preferably, a cover engages the channels on each of the upper sections, 32 and 34. Optionally, the cover may slidably engage, be press fit, snap fit, or retained by any other suitable means. The cover is preferably clear permitting light to radiate from the housing 20 without affecting the spectrum or transmission of the light. Optionally, the cover may be a diffuser to soften or otherwise modify the light emitted from the housing 20.

The upper sections, 32 and 34, are reflector portions of the housing 20 configured to help mix the spectra from the multiple white LEDs 72 and to help direct light through the first opening 55 along the upper face 25 of the housing 20. The housing 20 is preferably constructed of a substantially specular material. A specular surface will reflect incoming light at an angle of reflection and in a direction equal to the angle and direction of incidence. In contrast, diffuse surfaces have poor specularity and will cause some of the incoming light to be reflected at angles and/or directions other than the angle of incidence. The housing 20 is preferably constructed of extruded aluminum. It is contemplated that aluminum alloys or other materials having suitable specularity and rigidity may be used. The housing 20 may be coated with a clear, anti-corrosive coating to reduce oxidation of the material. Preferably, no reflective coating or material is applied to the inner surface of the housing 20.

In operation, the light fixture 8 emits white light over a range of color temperatures. The electronic components on the first side of the circuit board 70 provide electrical power to and control the intensity of the light output from the LEDs 72 on the second side of the circuit board 70. The power supply 18 is electrically connected to a voltage source, for example a positive twenty-four volt direct current (DC) voltage source, and controls power delivered to the LEDs 72. The electrical power may be provided using a current regulator 9, a PWM algorithm, or a combination thereof. Varying the power provided to the LEDs 72 causes light to be radiated at varying intensities.

Preferably, a processor 12 reads a program, or a series of instructions, from the memory device 13 to control the output of the light fixture 8. The light fixture 8 may, for example, have a series of first white LEDs 74 with a color temperature selected at one end of the desired range of color temperatures and a second series of white LEDs 76 with a color temperature selected at the other end of the desired range of color temperatures. The processor 12 executes the program to vary the intensity of each series of LEDs, 74 and 76, generating radiated white light across the desired range of color temperatures.

In one embodiment of the invention, the color temperature for the first white LEDs 74 is selected to be about 3500 K and the color temperature for the second white LEDs 76 is selected to be about 5000 K. The controller 11 provides control signals 17 to the power supply 18 which, in turn, provides power to each of the series of LEDs, 74 and 76, to vary the color temperature of the output light from about 3500 K to 5000 K. Although each of the white LEDs are specified according to the desired nominal color temperature, the actual color temperature of LEDs may vary as a result of manufacturing processes. Further, the variance among the LEDs may be great enough to be visibly discernable between individual LEDs or between multiple fixtures within a passenger compartment. Consequently, each controller 11 includes compensation data used to normalize the output of each light fixture 8 to compensate for variations in the actual color temperatures of individual LEDs.

A calibration routine determines compensation data, including, but not limited to proportionality constants, such that different light fixtures 8 output light at the same color temperature for a given set point despite variations in the actual LEDs 72. The calibration routine may be performed by an external device, by the controller 11, or a combination thereof The calibration routine preferably measures the actual color temperature output by the LEDs 72 and determines the calibration data which may be used by the controller to alter the intensity of one or both sets of LEDs, 74 or 76. For example, the calibration routine independently energizes the LEDs of each color temperature within a fixture 8. The color temperature of the resultant light is compared against the desired nominal color temperature, such as 3500K or 5000K. The LEDs of both color temperatures are then energized and blended to maintain a consistent intensity for the output light while adjusting the relative contribution of the LEDs of each color temperature such that the color temperature of the output light reaches the target set point at one end of the desired range of color temperatures. A first set of compensation data may be stored corresponding to the first target set point.

The LEDs of both color temperatures are again energized and blended to maintain a consistent intensity for the output light while adjusting the relative contribution of the LEDs of each color temperature such that the color temperature of the output light reaches the target set point at the opposite end of the desired range of color temperatures. A second set of compensation data may be stored corresponding to the second target set point. Optionally, the first and second set of compensation data may be combined to generate a single set of compensation data.

The compensation data is then applied to the control signals 17 sent to the power supply 18. The compensation data compensates for the variable properties of individual LEDs 72 such that the each fixture 8 generates light at the desired set point. Thus, a system having multiple fixtures 8 used to illuminate a single space generates light having a uniform color temperature from each fixture 8 throughout the space.

In order to vary the color temperature of the output light, the LEDs of each color temperature are operated at varying levels of intensity, ranging from constantly on to constantly off or any percentage of on time in between. In order to provide an intensity level other than fully on or fully off, the LED is preferably controlled by a PWM algorithm. The PWM algorithm alternately turns the voltage supplied to an LED on and off over a fixed period of time, T, referred to as a switching period. The amount of time the voltage is on versus the amount of time the voltage is off produces an average voltage which corresponds to the desired intensity level for the LEDs. For example, if an intensity level of twenty-five percent is desired, the voltage to the LEDs may be on for one quarter of the fixed time interval and off for three-quarters of the fixed time interval. The actual amount of on and off time may vary according the calibration of the LEDs to provide the actual nominal color temperature for the LEDs. According to one embodiment of the invention, the switching period is 2.5 milliseconds.

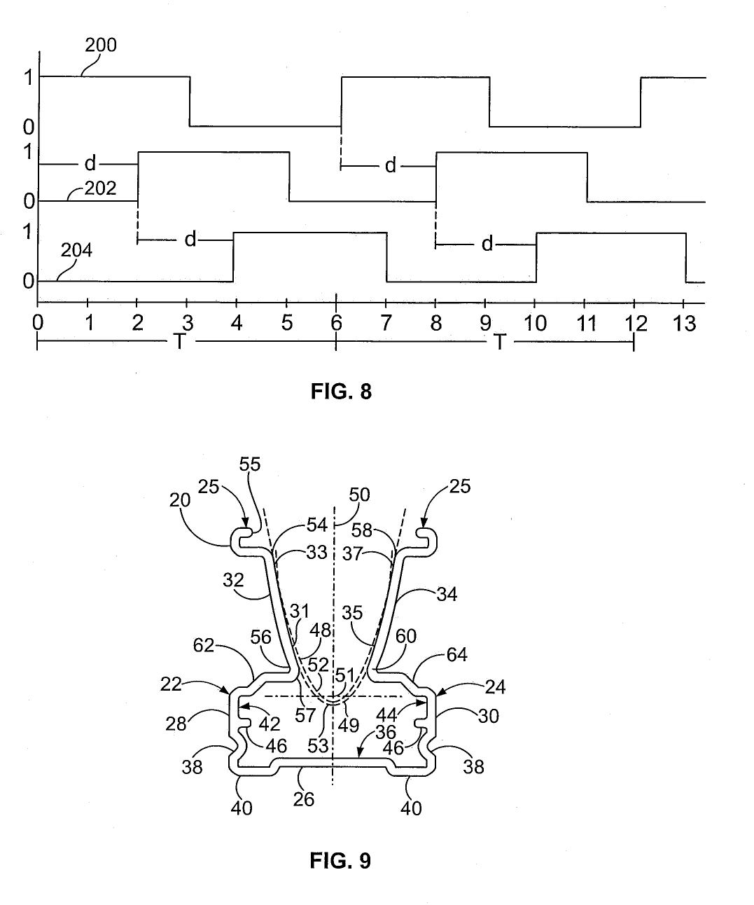

Referring to FIG. 8, three exemplary control signals, 200, 202, and 204, for PWM control are illustrated. Each control signal, 200, 202, and 204, controls the intensity of a different fixture 8. The vertical axis represents the state of each control signal by a zero (0) or a one (1) to indicate whether the control signal is on or off The control signal may be of any suitable voltage, such as 3.3 V, 5 V, or 24 V as required by the application. The horizontal axis represents the duration of each control signal by the increments 0-13, which may correspond to any suitable unit of time as required by the application. The control signals 200, 202, and 204, are on for a percentage of each switching period, T, corresponding to a desired intensity of the output light. If configured in a linear manner, for example, each control signal is commanded to be on between 0-100% of each period to radiate light at 0-100% of the rated intensity of the LEDs 72.

Referring also to FIG. 6, the light fixtures 8 may be arranged in series, parallel or a combination thereof and positioned about a passenger compartment. Typically, a single color temperature is desired for an entire passenger compartment. Preferably the controller 11 of one of the fixtures in the system acts as a master controller and the remaining controllers 11 act as followers. The master controller receives a reference signal indicative of a desired set point from an interface unit 14 or, optionally, over a network 19 from another system controller. The reference signal may include for example a desired intensity, color temperature, or other characteristic of the output light. The master controller then converts the reference signal to a suitable control signal 17. It is contemplated that the control signal 17 may be implemented as, but not limited to, one or more discrete logic signals, analog signals, or by serial or parallel communications. The master controller may then transmit either the original reference signal or a control signal to each of the followers via a network 19 such that each controller fixture 8 outputs light according to the reference signal, wherein the network 19 may be a standard network, such as Ethernet, or a custom, dedicated network configured to transmit information between controllers 11.

Because each of the light fixtures 8 typically receive the same nominal reference signal, the PWM algorithm for each fixture 8 would nominally switch the light source 10 of each fixture 8 on and off at substantially the same time. However, the PWM switching creates an inrush of current from the voltage source. Additionally, when each light fixture 8 is switched off, there is no current draw. Consequently, simultaneous switching of multiple fixtures 8 multiplies the inrush current and increases the steady state current drawn by the fixtures 8 and could also result in no current being drawn for portions of the switching period. Therefore, it would be preferable to spread out the on time of each light fixture 8 to maintain a more consistent current draw and reduce the magnitude of a current spike that may be generated by switching each of the light fixtures 8 at the same time.

Referring again to FIG. 8, the controller 11 preferably includes a propagation delay, d, between the start of the on time for each control signal, 200, 202, and 204. The delay, d, may be predetermined as a fixed value or, optionally, may be determined according to the number of light sources 10 present in the system. For example, the length of the delay, d, is preferably equal to the length of the switching period, T, divided by the number of light sources 10 in the system, and the value of the delay, d, is stored in the memory device 13 of each controller 11 for use by the PWM algorithm.

In the example illustrated in FIG. 8, there are three light sources 10. Each control signal, 200, 202, and 204, is used to control a switch 73 connecting the corresponding light source 10 to the voltage source. The controller 11, designated as master, generates the first control signal 200, which turns on at the beginning of the switching period, T. Coincident with the control signal 200 turning on, the master controller 11 generates a synchronizing signal. The synchronizing signal is passed from an output 90 of the master controller 11 to an input 92 on a second controller 11 which is next in a sequence to turn on. The second controller 11 waits to turn on the second control signal 202 for the duration of the delay, d. Coincident with the second control signal 202 turning on, the second controller 11 then generates a synchronizing signal. This synchronizing signal is passed from an output 90 of the second controller 11 to an input 92 of a third controller. The third controller 11 then waits to turn on the third control signal 204 for the duration of the delay, d. Although, the example illustrates the timing of control signals, 200, 202, and 204 generated by three controllers 11, any number of controllers 11 may be connected in series with each controller sequentially turning on its light source and generating a synchronizing signal to the next controller 11.

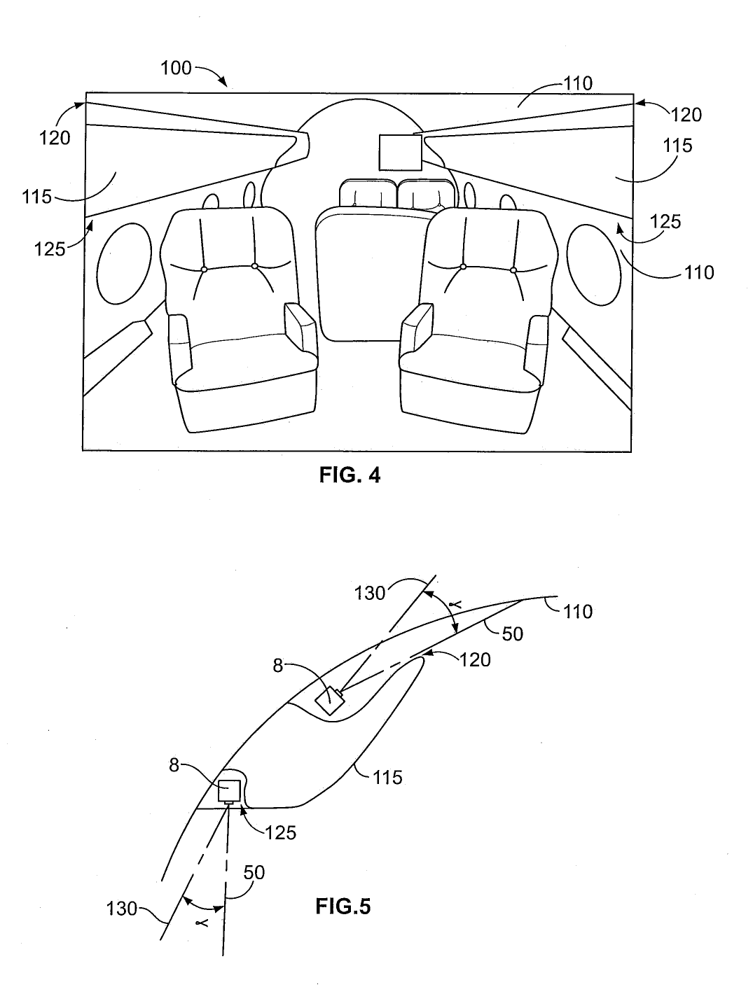

In one exemplary application of the invention, the light fixture 8 provides wash lighting for the interior of an aircraft cabin 100, as illustrated in FIGS. 4-5. As used herein, the light fixture 8 may identify a single fixture or alternately identify multiple fixtures positioned adjacent to or spaced apart from each other to provide lighting in the same direction along the length of one or multiple PSUs 115 within the cabin 100. At least one fixture 8 is enclosed within a PSU 115 connected to an upper portion of the air frame 110. An upper aperture 120 and a lower aperture 125 may be provided between the PSU 115 and the air frame 110 to permit light from the fixture 8 to radiate into the cabin 100. Alternately, a single LED light fixture 8 may be contained within the PSU to provide either an upward or a downward wash light or two LED light fixtures 8 may be contained within the PSU to provide both upwards and downwards wash lighting.

As illustrated in FIG. 5, the light fixture 8 may be recessed substantially behind the aperture 120 through which the light is radiated. The apertures 120 and 125 typically range from one half inch to four inches in width. Optionally, the fixture 8 may be used with apertures 120 and 125 greater than four inches in width. The fixture 8 is preferably configured to emit light at an off axis angle equal to or less than the maximum angle, α, at which the light will exit the aperture.

In order to emit light at an off axis angle equal to or less then the maximum angle, α, the housing 20 is configured to help direct and/or focus the light through one of the apertures, 120 or 125. For example, the upper sections, 32 and 34, of the housing 20 may be configured such that the light emitted from the housing 20 has an off center angle of about thirty degrees. In a first embodiment, illustrated in FIG. 11, the upper sections, 32 and 34, have a generally parabolic curvature. The LED 72 emits light at varying angles. On-axis rays 140 may be radiated directly away from the LED 72. Other directly emitted rays 142 are radiated at an off axis angle small enough such that they do not intersect the housing 20. In addition, directed rays 144 are radiated at an off axis angle of sufficient magnitude that they are reflected by the housing 20. Because the upper sections, 32 and 34, are generally parabolic, the directed rays 144 are reflected outward through the first opening 55 in a direction generally parallel to the first, on-axis rays 140, increasing the amount of light exiting the opening 55 in the housing 20.

In a second embodiment, illustrated in FIG. 12, the upper sections, 32 and 34, have a generally elliptical curvature. The LED 72 emits light at varying angles. On-axis rays 140 may be radiated directly away from the LED 72. Other directly emitted rays 142 are radiated at an off axis angle small enough such that they do not contact the housing 20. In addition, focused rays 146 are radiated at an off axis angle of sufficient magnitude that they are reflected by the housing 20. Because the upper sections, 32 and 34, are generally elliptical, the focused rays 146 are reflected outward through the first opening 55 toward a focal point 148 positioned on-axis and displaced from the LED 72, increasing the intensity of the light exiting the opening 55 in the housing 20.

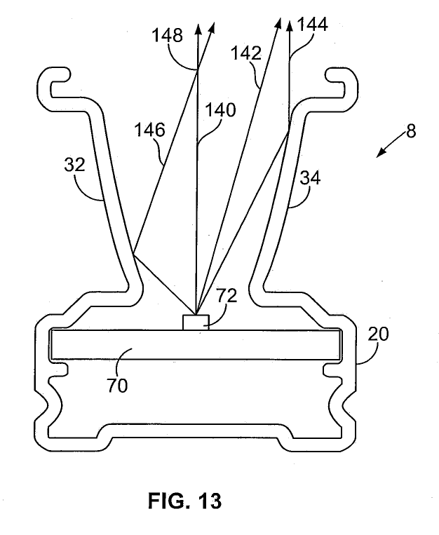

In a third embodiment, illustrated in FIG. 13, the upper sections, 32 and 34, may have at least two segments, one segment having a generally elliptical curvature and another segment having a generally parabolic curvature. The LED 72 emits light at varying angles. On-axis rays 140 may be radiated directly away from the LED 72. Other directly emitted rays 142 are radiated at an off axis angle small enough such that they do not contact the housing 20. Directed rays 144 are radiated at an off axis angle that intersects the parabolic segment and reflected outward through the first opening 55 in a direction generally parallel to the first, on-axis, rays 140. Focused rays 146 are radiated at an off axis angle that intersects the elliptical segment and reflected outward through the first opening 55 toward a focal point 148 positioned on-axis and displaced from the LED 72. The combination of directed rays 144 and focused rays 146 from the single housing 20 acts to increase both the amount and the intensity of the light exiting the opening 55 in the housing 20.

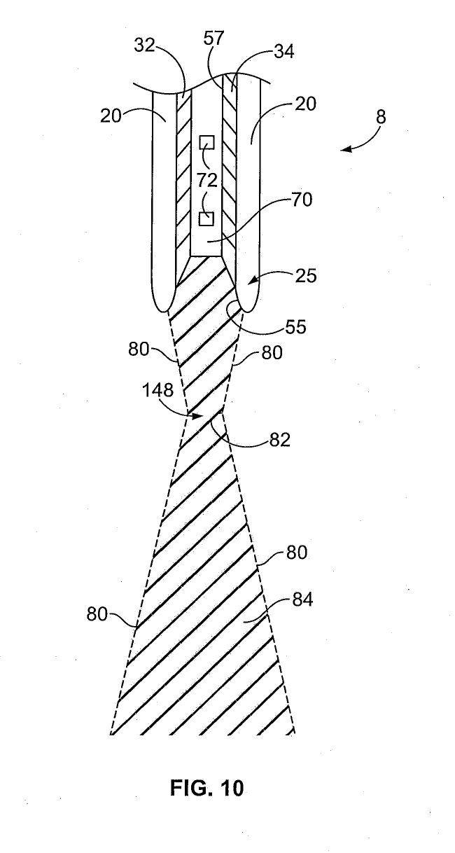

Referring to FIG. 10, a housing 20 having both an elliptical and a parabolic segment is illustrated. The radiated light is emitted in a pattern 84 generally outlined by lines 80. The light is first focused to its narrowest point 82 generally aligned with the focal point 148 defined by the elliptical segment of the housing 20. The light pattern 84 then increases in width as it travels beyond the focal point 148. Preferably, the housing 20 is positioned such that the narrowest point 82 of the radiated light pattern 84 aligns with an aperture 120 or 125 (referring to FIG. 5) through which the light must pass. The pattern 84 of radiation focuses light through the aperture 120 and then casts light outwardly onto the air frame 110. By configuring the housing 20 to increase the amount and intensity of light exiting an aperture 120 or 125, the fixture 8 illuminates a greater surface area of the air frame 110 without increasing the power to the fixture or the number of LEDs contained within the fixture.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A modular lighting system, comprising:
a voltage source; and
a plurality of lighting modules, each lighting module comprising:
at least one light source;
a power supply electrically connected to the voltage source and configured to regulate a current output from the power supply;
a processor configured to receive a reference signal and output a control signal corresponding to the reference signal; and
at least one switch selectively establishing an electrical connection between the power supply and the light source according to the control signal, wherein the electrical connections for the lighting modules are established at different times.

2. The modular lighting system of claim 1 wherein the output control signal is selectively energized using a pulse width modulation (PWM) algorithm.

3. The modular lighting system of claim 1 wherein each of the lighting modules are connected in series.

4. The modular lighting system of claim 1 wherein each lighting module further comprises an input configured to receive a synchronizing signal from at least one of the other lighting modules and an output configured to transmit a corresponding synchronizing signal to at least one of the other lighting modules.

5. The modular lighting system of claim 4 wherein each lighting module further comprises a memory device storing a delay time.

6. The modular lighting system of claim 5 wherein, in response to the control signal, a first of the lighting modules establishes the electrical connection between the power supply and the light source and generates the synchronizing signal for transmission to another of the lighting modules.

7. The modular lighting system of claim 6 wherein each of the other lighting modules sequentially receives one of the synchronizing signals from another of the lighting modules, waits for the delay time, establishes the electrical connection between the power supply and the light source, and generates the corresponding synchronizing signal for transmission to another of the lighting modules.

8. A modular lighting system, comprising
a voltage source; and
a plurality of lighting modules, each lighting module comprising:
a LED light source;
a power supply electrically connected to the voltage source and configured to regulate a current output from the power supply to the LED light source;
a switch connected in series between the power supply and the LED light source to establish an electrical connection between the power supply and the LED light source in a first operating mode and to break the electrical connection between the power supply and the LED light source in a second operating mode;
a processor configured to execute a pulse width modulation algorithm having a switching period, the processor having a control output to select either the first or the second operating mode of the switch, an input configured to receive a synchronizing signal from one of the other lighting modules, and an output configured to transmit a corresponding synchronizing signal to one of the other lighting modules; and
a memory device in communication with the processor storing a delay time,
wherein the processors of each of the lighting modules are synchronized to select either the first or the second operating mode of their respective switch at a different time.

9. The modular lighting system of claim 8 wherein the delay time is a function of the number of lighting modules and the switching period.

10. The modular lighting system of claim 8 wherein one of the lighting modules is designated as a master module and each of the remaining lighting modules are designated as a follower module.

11. The modular lighting system of claim 10 wherein the master module alternately toggles the switch between the first operating mode and the second operating mode for a percentage of the switching period corresponding to a desired intensity of light radiated from the LED light source.

12. The modular lighting system of claim 11 wherein the master module generates the synchronizing signal for transmission to a first of the follower modules when the switch is in the first operating mode.

13. The modular lighting system of claim 12 wherein the each follower module successively receives the synchronizing signal, waits for the delay time, sets its respective switch to the first operating mode, and generates a new synchronizing signal for transmission to the next follower module.

14. A method of controlling power supplied to a light system having a plurality of light modules, comprising the steps of:
receiving a reference signal corresponding to a desired intensity of light;
determining an on time for connecting a light source to a power supply on each light module as a function of the desired intensity and a switching period;
energizing each light source for the on time, wherein the on time is a portion of the switching period; and
staggering the start of the on time by a delay time for each successive light source.

15. The method of claim 14 wherein the delay time is substantially equal to the switching period divided by the number of light modules in the light system.

16. The method of claim 15 wherein each of the light modules are connected in series.

17. The method of claim 15 further comprising the steps of
generating a synchronizing signal at the start of the on time for each light module; and
transmitting the synchronizing signal to the next light module;

18. The method of claim 17 wherein the on time of a first light module is synchronized with the start of the switching period and wherein the on time of each subsequent light module begins after receiving the synchronizing signal from the prior light module and waiting for the delay time.
